(19) United States
(12) Patent Application Publication
(10) Pub. No.: US 2019/0296647 A1
(43) Pub. Date: Sep. 26, 2019

(54) Device and Method for Controlling Power Supply with Delay Behavior in a Power Circuit

(71) Applicants: Sanken Electric Co., Ltd., Saitama (JP); Sanken Electric Korea Co. Ltd., Seoul (KR)

(72) Inventors: Eun Suk LEE, Seoul (KR); Masaaki SHIMADA, Seoul (KR); Mi Yong KIM, Seoul (KR); Tetsuya TABATA, Saitama (JP); Hiroaki NAKAMURA, Saitama (JP)

(73) Assignees: Sanken Electric Co., Ltd., Saitama (JP); Sanken Electric Korea Co., Ltd., Seoul (KR)

(21) Appl. No.: 15/925,930

(22) Filed: Mar. 20, 2018

(51) Int. Cl. H02M 3/335

(52) U.S. Cl. CPC H02M 3/33507

(57) ABSTRACT

A device and method for controlling a power supply. The method includes: a voltage signal in a primary winding is delayed, and the delayed voltage signal is sampled and held after a time when a rectifying diode stops conducting a current, then the sampled and held signal is used as a feedback signal of the power supply. Therefore, only one sampling and holding circuit is needed, the area of the circuit can be reduced and the cost of the integrated circuit can be decreased, meanwhile regulation characteristics are not deteriorated.

### TECHNICAL FIELD

Embodiments of the present disclosure generally relate to the field of power supply, and more particularly, to a device and method for controlling a power supply.

### BACKGROUND

A power supply that is often used in telecommunications, transportation, industry and other applications may require electrical isolation between an input and an output of the power supply. A transformer with a primary winding and a secondary winding is often used to provide this isolation. Furthermore, the power supply may further include a switching element and a rectifying diode connected to the secondary winding.

In order to design a regulator that can be effectively used with a broad variety of transformers, a derived signal that is derived from the primary winding may be sampled and held, at a time when the primary winding is decoupled from an energy supplying circuit and the rectifying diode is conducting a current, and to hold the sampled value at least until the rectifying diode stops conducting the current. Therefore, the sampled and held signal can be used as a feedback signal to control the switching element.

Reference document 1: U.S. Pat. No. 7,463,497 B2

This section introduces aspects that may facilitate a better understanding of the disclosure. Accordingly, the statements of this section are to be read in this light and are not to be understood as admissions about what is in the prior art or what is not in the prior art.

### SUMMARY

However, the inventor found that at least two sampling and holding circuit are needed in the existing scheme, and the at least two sampling and holding circuit are configured to alternatively sample the derived signal during the rectifying diode keeps conducting the current, and respectively hold the sampled signal. Therefore, an area of a device for controlling the power supply is relatively large and it is difficult to decrease cost of an integrated circuit including the device for controlling the power supply.

In order to solve at least part of the above problems, methods, apparatus, devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a device and method for controlling a power supply. It is expected to reduce the area of the device and decrease the cost of the integrated circuit, meanwhile regulation characteristics are not deteriorated.

In a first aspect, a device for controlling a power supply is provided. The power supply includes a switching element, a transformer with a primary winding and a secondary winding, and a rectifying diode connected to the secondary winding; and

the device includes a delay circuit configured to delay a voltage signal in the primary winding; and a sampling and holding circuit configured to sample and hold the delayed voltage signal after a time when the rectifying diode stops conducting a current, and to output a feedback signal used for controlling the switching element.

In one embodiment, the device further includes a smooth filtering circuit configured between the delay circuit and the primary winding, and configured to filter a ringing voltage and/or a surging voltage of the voltage signal in the primary winding.

In one embodiment, the device further includes a snubber circuit connected to the primary winding and configured to filter a ringing voltage and/or a surging voltage of the voltage signal in the primary winding.

In one embodiment, the device further includes an error circuit configured to compare the feedback signal and a reference signal to generate an error signal; and a modulation circuit configured to generate a driving signal based on the error signal to control the switching element.

In one embodiment, a timing (or it may be referred to as an occasion) for sampling and holding the delayed voltage signal in the sampling and holding circuit is determined, based on one or more previous periods when the rectifying diode keeps conducting the current.

In one embodiment, a timing for sampling and holding the delayed voltage signal in the sampling and holding circuit is determined, based on a changed voltage in the primary winding when the rectifying diode stops conducting the current.

In one embodiment, the power supply further includes an auxiliary winding, and the device is further configured to control the switching element by using a voltage signal of the auxiliary winding.

In one embodiment, a period for sampling and holding the delayed voltage signal in the sampling and holding circuit comprises a duration from the time when the rectifying diode stops conducting a current to a time when the switching element is on.

In one embodiment, a period for sampling and holding the delayed voltage signal in the sampling and holding circuit is terminated in a duration in which the switching element is on.

In one embodiment, a drain electrode of the switching element is in a continuous conduction mode.

In a second aspect, an integrated circuit is provided. The integrated circuit includes a device for controlling a power supply as illustrated in the first aspect.

In a third aspect, a method for controlling a power supply is provided. The power supply includes a switching element, a transformer with a primary winding and a secondary winding, and a rectifying diode connected to the secondary winding; and

the method includes delaying a voltage signal in the primary winding; and sampling and holding the delayed voltage signal after a time when the rectifying diode stops conducting a current, and to output a feedback signal used for controlling the switching element.

In an embodiment, the method further includes filtering a ringing voltage and/or a surging voltage of the voltage signal in the primary winding.

In an embodiment, the method further includes comparing the feedback signal and a reference signal to generate an error signal; and generating a driving signal based on the error signal to control the switching element.

According to various embodiments of the present disclosure, a voltage signal in the primary winding is delayed, and the delayed voltage signal is sampled and held after a time when the rectifying diode stops conducting a current, then the sampled and held signal is used as a feedback signal of the power supply. Therefore, only one sampling and holding circuit is needed, the area of the device can be reduced and the cost of the integrated circuit can be decreased, meanwhile regulation characteristics are not deteriorated.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a schematic illustration of a power supply with a structure of SSR;

FIG. 2 is a diagram which shows a schematic illustration of a power supply with a structure of PSR;

FIG. 3 is a diagram which shows a schematic illustration of a power supply 300 and a device 310 for controlling the power supply 300 in accordance with an embodiment of the present disclosure;

FIG. 4 is another diagram which shows the schematic illustration of the power supply 300 and the device 310 for controlling the power supply 300 in accordance with an embodiment of the present disclosure;

FIG. 5 is a diagram which shows the signals in one or more of elements in FIG. 4 in accordance with an embodiment of the present disclosure;

FIG. 6 is another diagram which shows the schematic illustration of the power supply 300 and the device 310 for controlling the power supply 300 in accordance with an embodiment of the present disclosure;

FIG. 7 is a diagram which shows the signals in one or more of elements in FIG. 6 in accordance with an embodiment of the present disclosure;

FIG. 8 is a diagram which shows a method for controlling a power supply in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

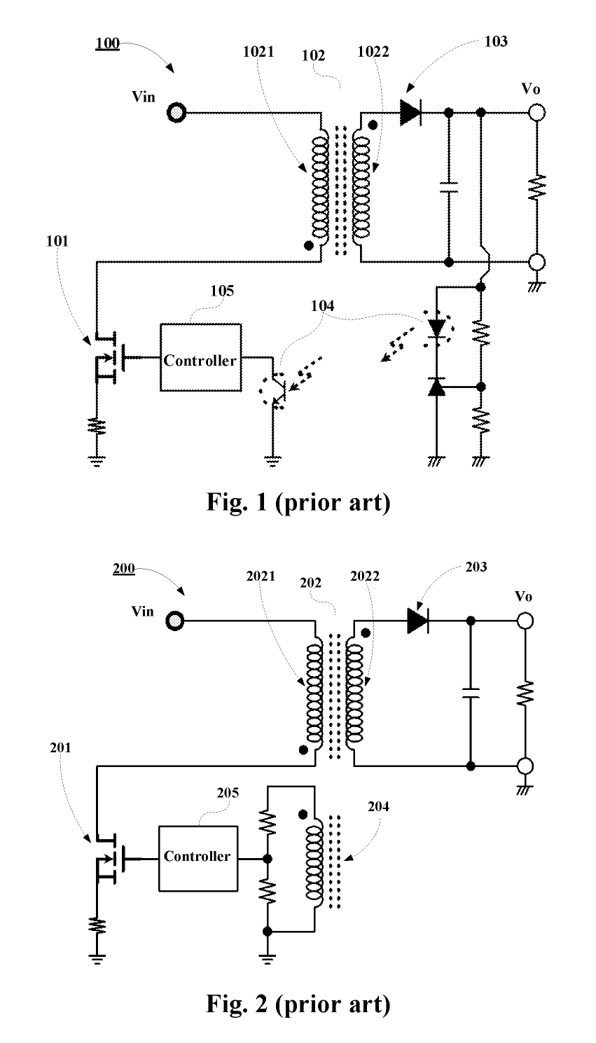

FIG. 1 is a diagram which shows a schematic illustration of a power supply with a structure of SSR (Secondary Side Regulation). As shown in FIG. 1, a power supply 100 is used to convert a first voltage (Vin, such as a direct current voltage or direct voltage) into a second voltage (Vo, such as a direct current voltage or direct voltage). The power supply 100 may include a switching element 101, a transformer 102 with a primary winding 1021 and a secondary winding 1022, a rectifying diode 103 connected to the secondary winding 1022.

As shown in FIG. 1, the power supply 100 may further include an optical coupler 104 and a controller 105. The optical coupler 104 is configured to couple a signal from a side of the secondary winding 1022 and output a feedback signal into the controller 105, and the controller 105 is configured to generate a driving signal to control the switching element 101.

FIG. 2 is a diagram which shows a schematic illustration of a power supply with a structure of PSR (Primary Side Regulation). As shown in FIG. 2, a power supply 200 is used to convert a first voltage (Vin, such as a direct current voltage or direct voltage) into a second voltage (Vo, such as a direct current voltage or direct voltage), and may include a switching element 201, a transformer 202 with a primary winding 2021 and a secondary winding 2022, a rectifying diode 203 connected to the secondary winding 2022.

As shown in FIG. 2, the power supply 200 may further include an auxiliary winding 204 and a controller 205. The auxiliary winding 204 is configured in a side of the primary winding 1021 and configured to output a feedback signal into the controller 205, and the controller 205 is configured to generate a driving signal to control the switching element 201.

It should be appreciated that some components or elements are illustrated as examples in FIG. 1 and FIG. 2. However, it is not limited thereto, for example, connections or positions of the components or elements may be adjusted, and/or, some components or elements may be omitted. Moreover, some components or elements not shown in FIG. 1 and FIG. 2 may be added, while components or elements shown in FIG. 1 and FIG. 2 but not explained may be referred in the relevant art.

However, the power supply 100 and the power supply 200 are still need some additional components, such as the optical coupler 104 and the auxiliary winding 204. Therefore, an area of the device is still relatively large and it is difficult to decrease cost of an integrated circuit.

In this disclosure, the feedback signal can be generated by using primary side sensing. Furthermore, the structure of PSR or SSR may be combined with the primary side sensing to improve performance of the power supply.

### A First Aspect of Embodiments

A device for controlling a power supply is provided in the embodiments.

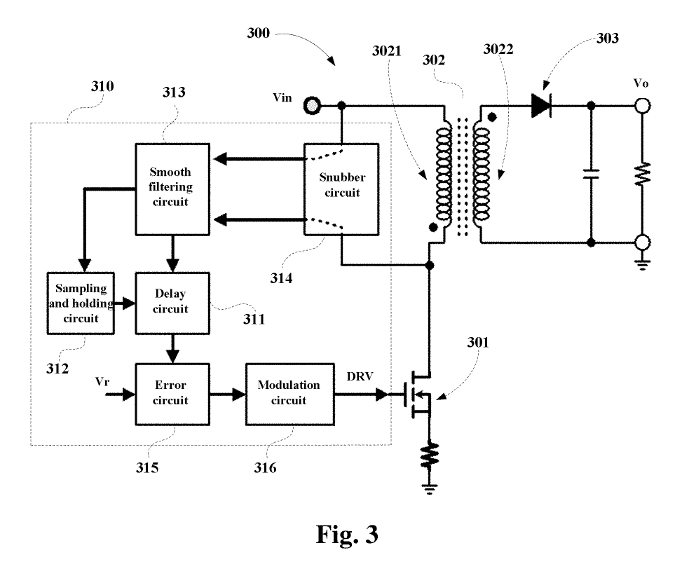

FIG. 3 is a diagram which shows a schematic illustration of a power supply 300 and a device 310 for controlling the power supply 300 in accordance with an embodiment of the present disclosure.

As shown in FIG. 3, the power supply 300 is used to convert a first voltage (Vin, such as a direct current voltage) into a second voltage (Vo, such as a direct current voltage). The power supply 300 may include a switching element 301, a transformer 302 with a primary winding 3021 and a secondary winding 3022, a rectifying diode 303 connected to the secondary winding 3022.

As shown in FIG. 3, the device 310 may include a delay circuit 311 configured to delay a voltage signal in the primary winding 3021; and a sampling and holding circuit 312 configured to sample and hold the delayed voltage signal after a time when the rectifying diode 303 stops conducting a current, and to output a feedback signal used for controlling the switching element 301.

Therefore, the feedback signal can be generated by using primary side sensing and only one sampling and holding circuit may be needed, the structure of the circuit can be simplified. Furthermore, the area of the device can be reduced and the cost of the integrated circuit can be decreased, meanwhile regulation characteristics are not deteriorated.

As shown in FIG. 3, the device 310 may further include a smooth filtering circuit 313 configured between the delay circuit 311 and the primary winding 3021, and the smooth filtering circuit 313 is configured to filter a ringing voltage and/or a surging voltage of the voltage signal in the primary winding 3021. For example, the smooth filtering circuit 313 may include a low pass filter (LPF).

As shown in FIG. 3, the device 310 may further include a snubber circuit 314 connected to the primary winding 3021; and the snubber circuit 314 is configured to filter a ringing voltage and/or a surging voltage of the voltage signal in the primary winding 3021.

Therefore, some noises or abnormal waveforms, such as those caused by a ringing voltage and/or a surging voltage, may be removed or decreased by using the smooth filtering circuit 313 and/or the snubber circuit 314. Regulation characteristics and stability of the system can be maintained or further improved.

As shown in FIG. 3, the device 310 may further include an error circuit 315 configured to compare the feedback signal and a reference signal to generate an error signal; and a modulation circuit 316 configured to generate a driving signal based on the error signal to control the switching element 301. For example, the modulation circuit 316 may generate some pulses as the driving signal to perform pulse width modulation (PWM).

It should be appreciated that some components or elements are illustrated as examples in FIG. 3. However, it is not limited thereto, for example, connections or positions of the components or elements may be adjusted, and/or, some components or elements may be omitted. Moreover, some components or elements not shown in FIG. 3 may be added, while components or elements shown in FIG. 3 but not explained may be referred in the relevant art.

Moreover, in FIG. 3, DRV denotes a driving signal, Vr denotes a reference voltage. However, it is not limited thereto, as for other labels or elements, some relevant arts may be used for reference.

In an embodiment, the switching element 301 may be, for instance, a transistor such as an IGFET (Insulated Gate Field Effect Transistor), a MOSFET (Metal Oxide Semiconductor Field Effect Transistor) or an IGBT (Insulated Gate Bipolar Transistor), and so on. The rectifying diode 303 may be of any type of diode, for instance, it may be a Schottky diode. Numerous other types of rectifying diodes and/or switching elements may be used in addition and/or instead, and it is not limited in this disclosure.

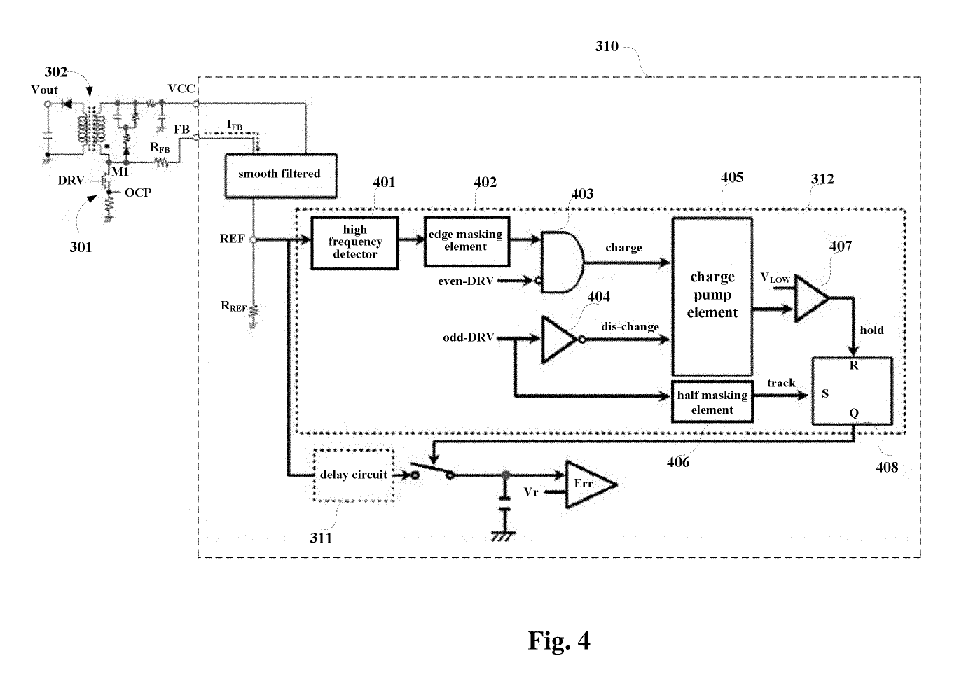

FIG. 4 is another diagram which shows the schematic illustration of the power supply 300 and the device 310 for controlling the power supply 300 in accordance with an embodiment of the present disclosure. It should be appreciated that the structure is only illustrated as an example in FIG. 4. However, it is not limited thereto, for example, some components or elements (such as elements in the sampling and holding circuit 312) are shown in FIG. 4 for the sake of clarification, while some components or elements (such as the modulation circuit 316) are omitted in FIG. 4 for the sake of simplify.

In FIG. 4, for example, DRV denotes a driving signal, OCP denotes an over current protection (OCP) signal, M1 denotes a drain electrode of the switching element, FB denotes a feedback terminal, REF denotes a reference terminal, Vr denotes a reference voltage, odd-DRV denotes an odd driving signal when the switching element is OFF, even-DRV denotes an even driving signal when the switching element is OFF. However, it is not limited thereto, as for the other labels, such as Vcc, S, R, Q, some relevant arts may be used for reference.

As shown in FIG. 4, the sampling and holding circuit 312 may include a high frequency detector 401 for detecting a high frequency signal in a falling edge, an edge masking element 402, a AND gate 403, a NOT gate 404, a charge pump element 405, a half masking element 406, a comparator 407 for detecting a low voltage and a holding element 408.

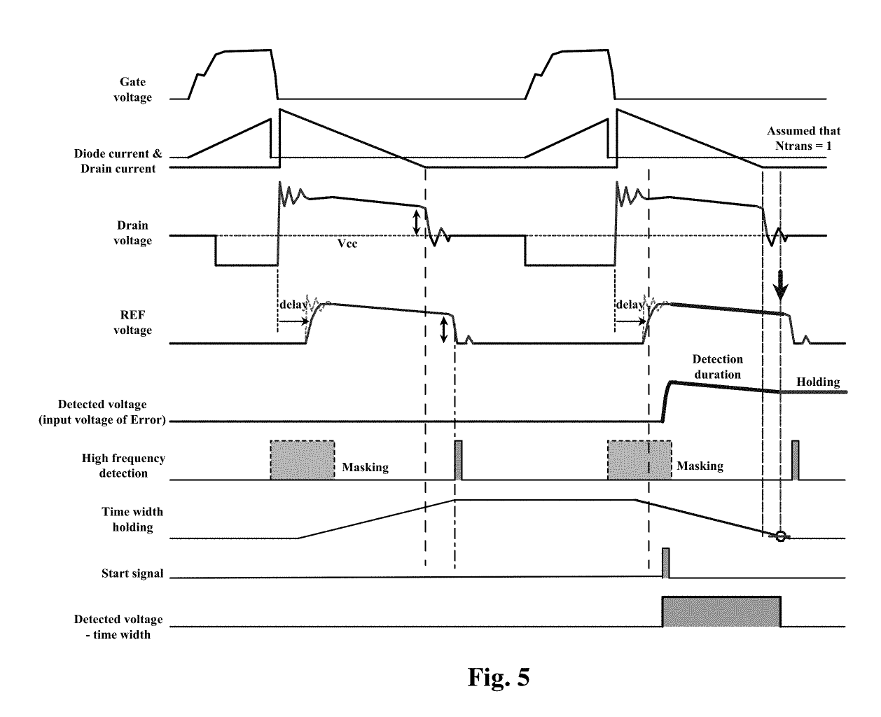

FIG. 5 is a diagram which shows the signals in one or more of elements in FIG. 4 in accordance with an embodiment of the present disclosure. As shown in FIG. 5, a voltage of the reference terminal (for example, see the REF voltage in FIG. 5) can be delayed and a feedback signal (for example, see the detected voltage in FIG. 5) can be generated.

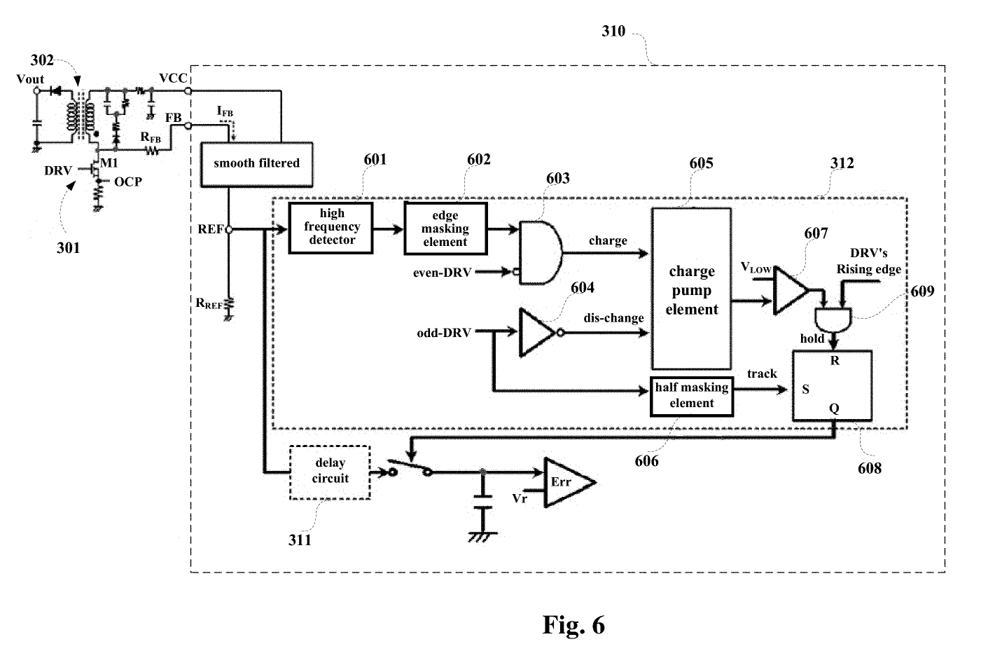

FIG. 6 is another diagram which shows the schematic illustration of the power supply 300 and the device 310 for controlling the power supply 300 in accordance with an embodiment of the present disclosure. It should be appreciated that the structure is only illustrated as an example in FIG. 6. However, it is not limited thereto, for example, some components or elements (such as elements in the sampling and holding circuit 312) are shown in FIG. 6 for the sake of clarification, while some components or elements (such as the modulation circuit 316) are omitted in FIG. 6 for the sake of simplify.

In FIG. 6, for example, DRV denotes a driving signal, OCP denotes an over current protection (OCP) signal, M1 denotes a drain electrode of the switching element, FB denotes a feedback terminal, REF denotes a reference terminal, Vr denotes a reference voltage, odd-DRV denotes an odd driving signal when the switching element is OFF, even-DRV denotes an even driving signal when the switching element is OFF. However, it is not limited thereto, as for the other labels, such as Vcc, S, R, some relevant arts may be used for reference.

As shown in FIG. 6, the sampling and holding circuit 312 may include a high frequency detector 601 for detecting a high frequency signal in a falling edge, an edge masking element 602, a AND gate 603, a NOT gate 604, a charge pump element 605, a half masking element 606, a comparator 607 for detecting a low voltage and a holding element 608.

As shown in FIG. 6, the sampling and holding circuit 312 may further include a AND gate 609 for outputting a signal based on an output signal from the comparator 607 and a rising edge of the driving signal (DRV).

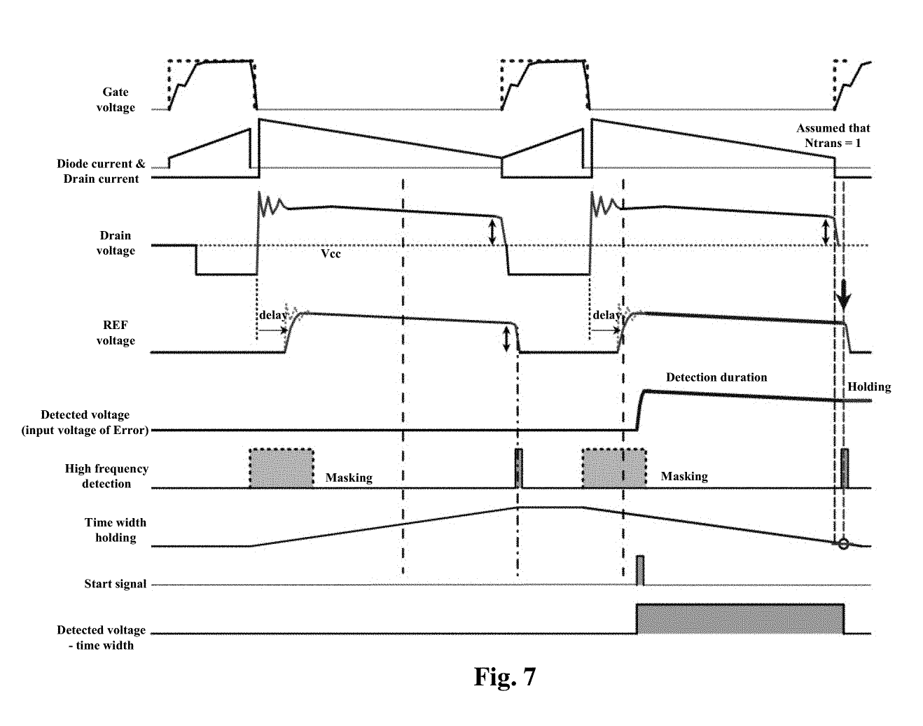

FIG. 7 is a diagram which shows the signals in one or more of elements in FIG. 6 in accordance with an embodiment of the present disclosure. As shown in FIG. 7, a voltage of the reference terminal (for example, see the REF voltage in FIG. 7) can be delayed and a feedback signal (for example, see the detected voltage in FIG. 7) can be generated.

Furthermore, the drain current of the switching element 301 can be a continuous triangle waveform in FIG. 7, while the drain current of the switching element 301 can be a non-continuous triangle waveform in FIG. 5. That is, in the structure of FIG. 7, a drain electrode of the switching element 301 may be kept in a continuous conduction mode (CCM).

The structures and the operations are illustrated as examples of this disclosure, and it is not limited thereto. Next, timing and duration of the sampling and holding will be schematically illustrated.

In an embodiment, a timing for sampling and holding the delayed voltage signal in the sampling and holding circuit 312 may be determined, based on one or more previous periods when the rectifying diode keeps conducting the current.

Therefore, according to one or more previous switching periods, a timing of a next sampling and holding can be set or configured. The sampling and holding may be triggered correctly and accuracy of the sampling and holding may be improved.

In an embodiment, a timing for sampling and holding the delayed voltage signal in the sampling and holding circuit 312 may be determined, based on a changed voltage in the primary winding when the rectifying diode stops conducting the current.

Therefore, according to the change information of the voltage in the primary winding, a timing of a next sampling and holding can be set or configured. The sampling and holding may be triggered promptly and efficiency of the sampling and holding may be improved.

In an embodiment, the power supply 300 may further include an auxiliary winding, and the device 310 may further be configured to control the switching element 301 by using a voltage signal of the auxiliary winding.

Therefore, the structure of PSR may be combined with the primary side sensing, and performance of the power supply may be improved.

In an embodiment, a period for sampling and holding the delayed voltage signal in the sampling and holding circuit 312 may include a duration from the time when the rectifying diode 303 stops conducting a current to a time when the switching element 301 is on.

Therefore, the sampling and holding may be performed efficiently and correctly, and performance of the power supply may be improved.

In an embodiment, a period for sampling and holding the delayed voltage signal in the sampling and holding circuit 312 may be terminated in a duration in which the switching element 301 is on. For example, a drain electrode of the switching element 301 is in a continuous conduction mode (CCM).

Therefore, the sampling and holding may be performed efficiently and correctly, and performance of the power supply may be improved.

In an embodiment, an integrated circuit (IC) is provided. The integrated circuit includes a device for controlling a power supply as illustrated in above.

It is to be understood that, the above examples or embodiments are discussed for illustration, rather than limitation. Those skilled in the art would appreciate that there may be many other embodiments or examples within the scope of the present disclosure.

As can be seen from the above embodiments, a voltage signal in the primary winding is delayed, and the delayed voltage signal is sampled and held after a time when the rectifying diode stops conducting a current, then the sampled and held signal is used as a feedback signal of the power supply. Therefore, only one sampling and holding circuit is needed, the area of the device can be reduced and the cost of the integrated circuit can be decreased, meanwhile regulation characteristics are not deteriorated.

### A Second Aspect of Embodiments

A method for controlling a power supply is provided in the embodiments. The corresponding device 310 and the power supply 300 are illustrated in the first aspect of embodiments, and the same contents as those in the first aspect of embodiments are omitted.

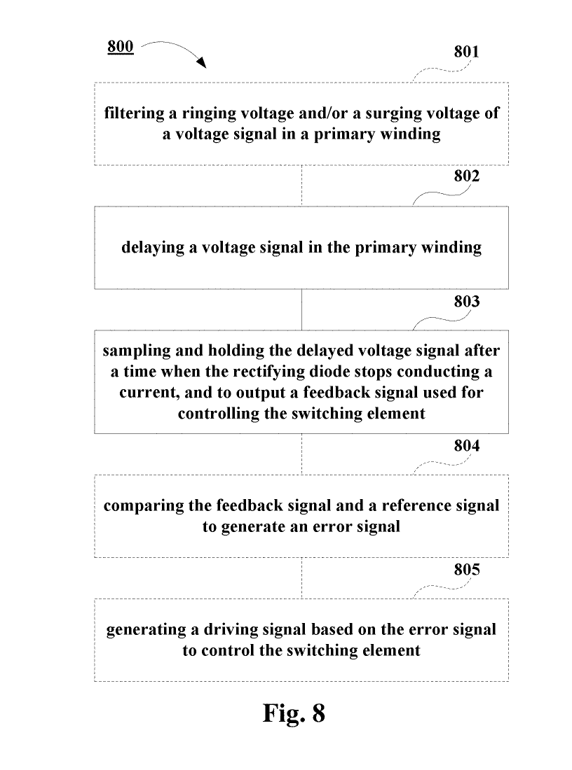

FIG. 8 is a diagram which shows a method for controlling a power supply in accordance with an embodiment of the present disclosure. As shown in FIG. 8, the method 800 includes:

Block 802, delaying a voltage signal in the primary winding; and

Block 803, sampling and holding the delayed voltage signal after a time when the rectifying diode stops conducting a current, and to output a feedback signal used for controlling the switching element.

As shown in FIG. 8, the method may further include:

Block 801, filtering a ringing voltage and/or a surging voltage of the voltage signal in the primary winding.

As shown in FIG. 8, the method may further include:

Block 804, comparing the feedback signal and a reference signal to generate an error signal; and

Block 805, generating a driving signal based on the error signal to control the switching element.

It should be appreciated that FIG. 8 is only an example of the disclosure, but it is not limited thereto. For example, the order of operations at blocks may be adjusted, and/or, some blocks or steps may be omitted. Moreover, some blocks or steps not shown in FIG. 8 may be added.

In an embodiment, a timing for sampling and holding the delayed voltage signal is determined, based on one or more previous periods when the rectifying diode keeps conducting the current.

In an embodiment, a timing for sampling and holding the delayed voltage signal is determined, based on a changed voltage in the primary winding when the rectifying diode stops conducting the current.

In an embodiment, the power supply may further include an auxiliary winding, and the method further include: controlling the switching element by using a voltage signal of the auxiliary winding.

In an embodiment, a period for sampling and holding the delayed voltage signal comprises a duration from the time when the rectifying diode stops conducting a current to a time when the switching element is on.

In an embodiment, a period for sampling and holding the delayed voltage signal is terminated in a duration in which the switching element is on. For example, a drain electrode of the switching element is in a continuous conduction mode.

As can be seen from the above embodiments, a voltage signal in the primary winding is delayed, and the delayed voltage signal is sampled and held after a time when the rectifying diode stops conducting a current, then the sampled and held signal is used as a feedback signal of the power supply. Therefore, only one sampling and holding circuit is needed, the area of the device can be reduced and the cost of the integrated circuit can be decreased, meanwhile regulation characteristics are not deteriorated.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device for controlling a power supply; the power supply comprising a switching element, a transformer with a primary winding and a secondary winding, and a rectifying diode connected to the secondary winding;
wherein the device comprises:
a smooth filtering circuit configured to filter at least one of a ringing voltage and a surging voltage of a voltage signal in the primary winding and pass a voltage greater than a reference voltage and to generate a filtered voltage signal;
a snubber circuit connected to the primary winding, wherein the snubber circuit is configured to filter at least one of the ringing voltage and the surging voltage of the voltage signal in the primary winding;
a delay circuit configured to delay the filtered voltage signal from the smooth filtering circuit and generate a delayed voltage signal; and
a sampling and holding circuit configured to sample and hold the delayed voltage signal after a time when the rectifying diode stops conducting a current, and to output a feedback signal used for controlling the switching element.

2. (canceled)

3. (canceled)

4. The device according to claim 1, wherein the device further comprises:
an error circuit configured to compare the feedback signal and a reference signal to generate an error signal; and
a modulation circuit configured to generate a driving signal based on the error signal to control the switching element.

5. The device according to claim 1, wherein a timing for sampling and holding the delayed voltage signal in the sampling and holding circuit is determined based on one or more previous periods when the rectifying diode keeps conducting the current.

6. The device according to claim 1, wherein a timing for sampling and holding the delayed voltage signal in the sampling and holding circuit is determined based on a changed voltage in the primary winding when the rectifying diode stops conducting the current.

7. The device according to claim 1, wherein the power supply further comprises an auxiliary winding, and the device is further configured to control the switching element by using a voltage signal of the auxiliary winding.

8. The device according to claim 1, wherein a period for sampling and holding the delayed voltage signal in the sampling and holding circuit comprises a duration from the time when the rectifying diode stops conducting the current to a time when the switching element is on.

9. The device according to claim 1, wherein a period for sampling and holding the delayed voltage signal in the sampling and holding circuit is terminated in a duration in which the switching element is on.

10. The device according to claim 9, wherein a drain electrode of the switching element is in a continuous conduction mode.

11. An integrated circuit, comprising a device for controlling a power supply as claimed in claim 1.

12. A method for controlling a power supply; the power supply comprising a switching element, a transformer with a primary winding and a secondary winding, and a rectifying diode connected to the secondary winding;
wherein the method comprises:
filtering, using a smooth filtering circuit and a snubber circuit, at least one of a ringing voltage and a surging voltage of a voltage signal in the primary winding and passing a voltage greater than a reference voltage to generate a filtered voltage signal;
delaying the filtered voltage signal and generating a delayed voltage signal; and
sampling and holding the delayed voltage signal after a time when the rectifying diode stops conducting a current, and to output a feedback signal used for controlling the switching element.

13. (canceled)

14. The method according to claim 12, wherein the method further comprises:
comparing the feedback signal and a reference signal to generate an error signal; and
generating a driving signal based on the error signal to control the switching element.

15. The method according to claim 12, wherein a timing for sampling and holding the delayed voltage signal is determined based on one or more previous periods when the rectifying diode keeps conducting the current.

16. The method according to claim 12, wherein a timing for sampling and holding the delayed voltage signal is determined based on a changed voltage in the primary winding when the rectifying diode stops conducting the current.

17. The method according to claim 12, wherein the power supply further comprises an auxiliary winding, and the method further comprises:
controlling the switching element by using a voltage signal of the auxiliary winding.

18. The method according to claim 12, wherein a period for sampling and holding the delayed voltage signal comprises a duration from the time when the rectifying diode stops conducting the current to a time when the switching element is on.

19. The method according to claim 12, wherein a period for sampling and holding the delayed voltage signal is terminated in a duration in which the switching element is on.

20. The method according to claim 19, wherein a drain electrode of the switching element is in a continuous conduction mode.
